(19) United States
(12) Patent Application Publication
(10) Pub. No.: US 2017/0171393 A1
(43) Pub. Date: Jun. 15, 2017

(54) Method and Device for Call

(71) Applicants: Le Holdings (Beijing) Co., Ltd., Beijing (CN); Le Shi Zhi Xin Electronic Technology (Tianjin) Limited, Beijing (CN)

(72) Inventors: Ning Cheng, Beijing (CN); Xun Xv, Beijing (CN); Hua Kang, Beijing (CN)

(73) Assignees: Le Holdings (Beijing) Co., Ltd., Beijing (CN); Le Shi Zhi Xin Electronic Technology (Tianjin) Limited, Beijing (CN)

(21) Appl. No.: 15/245,929

(22) Filed: Aug. 24, 2016

Related U.S. Application Data
(63) Continuation-in-part of application No. PCT/CN2016/088124, filed on Jul. 1, 2016.

(30) Foreign Application Priority Data
Dec. 15, 2015 (CN) 201510934464.4

(51) Int. Cl. H04M 7/00; H04N 21/426; H04N 21/4788; H04N 7/14; H04N 21/61

(52) U.S. Cl. CPC H04M 7/006; H04N 7/147; H04N 21/6125; H04N 21/6175; H04N 21/4788; H04N 21/42684

(57) ABSTRACT

Disclosed are a method and device for a call, wherein the method includes: receiving by a calling terminal an identifier of a called terminal and multimedia information that are input by a user, generating a calling request message according to an identifier of the calling terminal, the identifier of the called terminal and the multimedia information, and sending the calling request message to the called terminal. According to the embodiments of the present disclosure, individualized multimedia information is added to the calling request by the calling terminal, such that the multimedia information is displayed simultaneously on the called terminal when the calling request is received; therefore, the problem in the prior art that information displayed during calling is uninteresting and low in information content and lacks individuality is solved, and the process of calling is enabled to be individualized and interesting.

### CROSS-REFERENCE TO RELATED APPLICATIONS

This application is a continuation-in-part of International Application No. PCT/CN2016/088124, filed on Jul. 1, 2016, which is based upon and claims priority to Chinese Patent Application No. 201510934464.4, filed on Dec. 15, 2015, the entire contents of which are incorporated herein by reference.

### TECHNICAL FIELD

The present disclosure relates to the field of smart terminal application, in particular to a method and device for a call and a terminal.

### BACKGROUND

With the increase of network utilization, the user's scale of network TVs is larger and larger. Due to such characteristics as large screen, high video coding capability, simple operation and the like of TVs, the proportion of making video calls using the network TVs also increases gradually.

At present, while making a video call or a voice call via a network TV, typically, the calling party originates a calling request, and the called party receives the calling request. The calling party may originate a video call by directly dialing a number of the called party, and an incoming call number of the calling party will be displayed on a device of the called party after the called party receives the calling request. However, only the incoming call number can be displayed in the calling process, and any other individualized information cannot be provided. Therefore, the information displayed during calling is uninteresting and low in information content, and lacks individuality.

Hence, it becomes a problem to be urgently solved, i.e., how to add individualized information during calling to enable the process of calling to be individualized and interesting.

### SUMMARY

Aiming at the defect in the prior art, embodiments of the present disclosure provide a method and device for a call and a terminal, thereby solving the problem in the prior art that the information displayed during calling is uninteresting and low in information content and lacks individuality, and enabling the process of calling to be individualized and interesting.

In order to solve the above technical problem, the embodiments of the present disclosure provide the following technical solutions:

One embodiment of the present disclosure provides a method for a call. The method includes: receiving by a calling terminal an identifier of a called terminal and multimedia information that are input by a user; generating a calling request message according to an identifier of the calling terminal, the identifier of the called terminal and the multimedia information; sending the calling request message to the called terminal.

Still another embodiment of the present disclosure provides an electronic device for a call, comprising: at least one processors; a memory; and at least one modules stored in the memory, the at least one modules are configured to perform the following operations when being executed by the at least one processors: receiving an identifier of a called terminal and multimedia information that are input by a user; generating a calling request message according to an identifier of a calling terminal, the identifier of the called terminal and the multimedia information; sending the calling request message to the called terminal.

Still another embodiment of the present disclosure provides a non-volatile computer readable storage medium, where the non-volatile computer readable storage medium stores a computer instruction, and a computer executes the computer instruction to execute the following operations: receiving by a calling terminal an identifier of a called terminal and multimedia information that are input by a user; generating a calling request message according to an identifier of the calling terminal, the identifier of the called terminal and the multimedia information; sending the calling request message to the called terminal.

According to the above technical solutions, the method and device for a call and the terminal provided by the embodiments of the present disclosure have the following advantages: individualized multimedia information may be added to a calling request by the calling terminal, and the multimedia information will be displayed on the called terminal when the calling request is received; therefore, the problem in the prior art that the information displayed during calling is uninteresting and low in information content and lacks individuality is solved, and the process of calling is enabled to be individualized and interesting. Thus, in case of an incoming call, a more effective judgment can be made on whether the call is answered by the called terminal according to the individualized information. Hence, practicability and interestingness of calling are enhanced.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow schematic diagram of a method for a call provided by an embodiment of the present disclosure.

FIG. 2 is a flow schematic diagram of a method for a call provided by another embodiment of the present disclosure.

FIG. 3 is a structural schematic diagram of a device for a call provided by an embodiment of the present disclosure.

FIG. 4 is a structural schematic diagram of a device for a call provided by another embodiment of the present disclosure.

FIG. 5 is a structural schematic diagram of a terminal provided by an embodiment of the present disclosure.

FIG. 6 is a structural schematic diagram of a terminal provided by another embodiment of the present disclosure.

### DESCRIPTION OF THE EMBODIMENTS

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part, but not all, of the embodiments of the present disclosure. All of other embodiments, obtained by a person of ordinary skill in the art based on the embodiments in the present disclosure without any creative effort should fall into the protection scope of the present disclosure.

FIG. 1 shows the flow schematic diagram of the method for a call provided by one embodiment of the present disclosure. As shown in FIG. 1, the method includes the following steps:

S101, a calling terminal receives an identifier of a called terminal and multimedia information that are input by a user.

In this step, the calling terminal and the called terminal generally refer to terminals capable of realizing voice calls or video calls, for example, network TVs, smart phones, personal digital assistants (PDAs), tablet computers, notebook computers, carputers, smart glasses, smart watches and the like.

Wherein, the identifier of the called terminal includes: identity (ID) information of the called terminal, Internet protocol (IP) information of the called terminal, Media Access Control (MAC) address information of the called terminal or the like. The multimedia information includes text information (emotion information), image information, video information, audio information, etc.

S102, a calling request message is generated according to an identifier of the calling terminal, the identifier of the called terminal and the multimedia information.

Wherein, the identifier of the calling terminal includes: identity (ID) information of the calling terminal, Internet protocol (IP) information of the calling terminal, Media Access Control (MAC) address information of the calling terminal or the like.

S103, the calling request message is sent to the called terminal.

Hence, in this embodiment, the individualized multimedia information is added to the calling request by the calling terminal, and the multimedia information will be displayed on the called terminal when the calling request is received; therefore, the problem in the prior art that the information displayed during calling is uninteresting and low in information content and lacks individuality is solved, and the process of calling is enabled to be individualized and interesting.

In another embodiment of the present disclosure, provided is a specific implementation of the above step S101. Specifically, step S101 includes the following substeps:

S11, the calling terminal sends a prompt message for prompting the user whether to add the multimedia information upon receiving the identifier of the called terminal input by the user.

Specifically, when a video call or a voice call is made by the calling terminal, an input box for inputting the identifier of the called terminal is detected in real time. If completion of inputting the identifier of the called terminal in the input box is detected, the prompt message is sent to allow the user to determine whether the multimedia information is added. If the user determines to add the multimedia information, step S12 is executed; or otherwise, the calling request message is generated directly according to the identifier of the called terminal and the identifier of the calling terminal, and then sent to the called terminal.

S12, the multimedia information input by the user and having capacity smaller than a preset threshold is acquired if the user determines to add the multimedia information.

Specifically, if the user determines to add the multimedia information, an input box for adding the multimedia information is displayed on an interface. The input box may include an ADD button for directly adding a path of an existing multimedia file (i.e., a preset address for storing a multimedia file), a text input box for directly inputting text information, a RECORD button for recording voice or a short video using a microphone or a camera, etc.

Further, if the user determines to add the multimedia information, a judgment is made on whether the added multimedia information is smaller than a preset threshold; if so, the multimedia information is acquired; or otherwise, a prompt is given that the capacity or the size of the multimedia information added by the user is unsatisfactory. For example, it may be limited that the size of the multimedia information is smaller than or equal to 500 k. Thus, the size of the multimedia information may be limited to prevent the case that the multimedia information is too large and affects the sending of the calling request information.

Further, according to different ways of obtaining the multimedia information, the multimedia information may be divided into:

A1: audio information, video information or image information stored at a preset address;

A2: audio information, video information or image information input by means of a microphone or a camera;

A3: text information input by means of a keyboard.

Accordingly, if the multimedia information is the information as described in A1, step S12 further includes:

receiving the preset address corresponding to the multimedia information input by the user and obtaining the multimedia information from the preset address.

If the multimedia information is the information as described in A2, step S12 further includes:

acquiring voice data of a microphone, and acquiring video data or shot image information of a camera to generate the multimedia information.

If the multimedia information is the information as described in A3, step S12 further includes:

obtaining the multimedia information, i.e., text information (emotion information), input by means of the keyboard.

It needs to be noted that the keyboard may be a peripheral keyboard connected to the calling terminal or a virtual keyboard set in the calling terminal, which is not limited herein.

It thus can be seen that concerning the multimedia information sent to the called terminal, text information or emotion information may be directly input, or the existing multimedia files may be selected; alternatively, live voice or short videos may be recorded to generate multimedia files. More individualized multimedia information thus can be obtained to further improve the interestingness of the calling process.

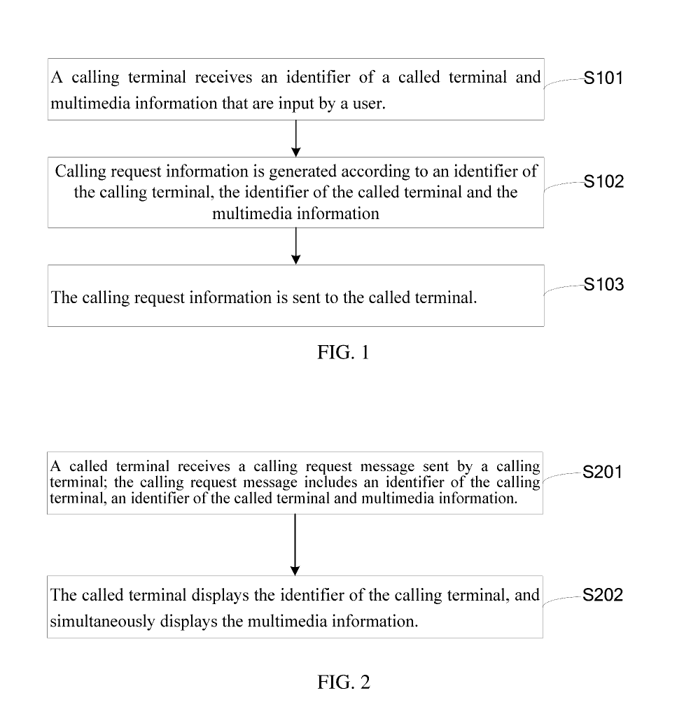

FIG. 2 shows the flow schematic diagram of the method for a call provided by another embodiment of the present disclosure. As shown in FIG. 2, the method includes the following steps:

S201: a called terminal receives a calling request message sent by a calling terminal.

Wherein, the calling request message includes an identifier of the calling terminal, an identifier of the called terminal and multimedia information, wherein the identifier of the called terminal and the identifier of the calling terminal are both used for uniquely identifying the corresponding terminals, and may include: ID information, IP information, MAC address information, etc.

S202, the called terminal displays the identifier of the calling terminal, and simultaneously displays the multimedia information.

In this step, the called terminal displays the identifier of the calling terminal after acquiring the calling request message; if the calling request message includes the multimedia information, the called terminal simultaneously displays the multimedia information.

It could be appreciated that before displaying, the called terminal also judges whether the calling request message includes the multimedia information. If so, the multimedia information is displayed while the identifier of the calling terminal is displayed; or otherwise, only the identifier of the calling terminal is displayed.

It needs to be noted that the called terminal performs matching on the identifier of the calling terminal and identifiers in a contact list after receiving the calling request message, and displays the name of the calling terminal if the matching succeeds. For example, if the identifier of the calling terminal is matched with the calling terminal identifier of Sister LELE in the contact list, a prompt box “Sister LELE requests for a video call with you” is directly displayed. If matching fails, the identifier of the calling terminal is directly displayed.

It thus can be seen that in this embodiment, when the called terminal receives the calling request, if the calling request includes the multimedia information, the multimedia information will be displayed while the number of the calling terminal is displayed, such that the calling process is individualized and interesting. Meanwhile, an effective judgment can be made on whether the call is answered by the called terminal according to the content of the multimedia information. Hence, the individualized calling request leads to great improvement of practicability and interestingness of calling.

Further, the multimedia information may include text information, audio information, video information, image information and so on.

Accordingly, according to different contents of the received multimedia information, the multimedia information may be displayed differently; step S202 of displaying the multimedia information thus may specifically include:

displaying the text information or the image information in a preset display box;

playing the audio information or the video information in a preset player.

In this way, after the calling request is received by the called party, the content of the multimedia attachment is displayed in the display box while the called number is displayed. For example, text (emotion) content is directly displayed in the text box; image information is directly displayed in the preset display box; and a voice message or short video content is directly played via the player.

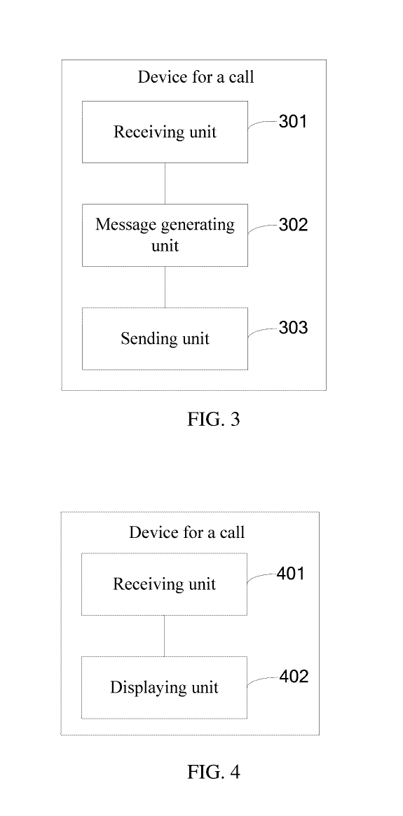

FIG. 3 shows the structural schematic diagram of the device for a call provided by one embodiment of the present disclosure. The device includes a receiving unit 301, a message generating unit 302 and a sending unit 303. Wherein:

the receiving unit 301 is used for receiving an identifier of a called terminal and multimedia information that are input by a user.

The message generating unit 302 is used for generating a calling request message according to an identifier of a calling terminal, the identifier of the called terminal and the multimedia information.

The sending unit 303 is used for sending the calling request message to the called terminal.

Wherein, the identifier of the called terminal includes: identity (ID) information of the called terminal, Internet protocol (IP) information of the called terminal or Media Access Control (MAC) address information of the called terminal.

The identifier of the calling terminal includes: identity (ID) information of the calling terminal, Internet protocol (IP) information of the calling terminal or Media Access Control (MAC) address information of the calling terminal.

In this embodiment, the receiving unit 301 is used for:

sending a prompt message for prompting the user whether to the add multimedia information upon receiving the identifier of the called terminal input by the user;

acquiring the multimedia information input by the user and having capacity smaller than a preset threshold if the user determines to add the multimedia information.

Wherein, the multimedia information includes:

audio information, video information or image information stored at a preset address; and/or

audio information, video information or image information input by means of a microphone or a camera; and/or

text information input by means of a keyboard.

The device for a call described in this embodiment may be used for executing the method for a call described in the above first embodiment, and is similar to the method in principle and technical effects, which are not redundantly described herein.

Another embodiment of the present disclosure provides a terminal. The terminal includes the device for a call that includes the receiving unit 301, the message generating unit 302 and the sending unit 303, as described above. For example, the terminal may be a network TV, a smart phone or the like.

Since the terminal described in this embodiment includes the device for a call described in the above embodiment, the terminal described in this embodiment is capable of solving the problem in the prior art that information displayed during calling is uninteresting and low in information content and lacks individuality and enabling the process of calling to be individualized and interesting in the following way: the individualized multimedia information is added to the calling request, such that the called terminal displays the multimedia information at the same time of receiving the calling request.

FIG. 4 shows the structural schematic diagram of the device for a call provided by another embodiment of the present disclosure. The device includes: a receiving unit 401 and a displaying unit 402. Wherein:

the receiving unit 401 is used for receiving a calling request message sent by a calling terminal, wherein the calling request message includes an identifier of the calling terminal, an identifier of the called terminal and multimedia information.

The displaying unit 402 is used for displaying the identifier of the calling terminal, and simultaneously displaying the multimedia information.

Wherein, the multimedia information includes: text information, audio information, video information and image information.

Accordingly, the displaying unit 402 is used for:

displaying the text information or the image information in a preset display box;

playing the audio information or the video information in a preset player.

The device for a call described in this embodiment may be used for executing the method for a call described in the above second embodiment, and is similar to the method in principle and technical effects, which are not redundantly described herein.

Another embodiment of the present disclosure provides a terminal. The terminal includes the device for a call that includes the receiving unit 401 and the displaying unit 402, as described above. For example, the terminal may be a network TV, a smart phone or the like.

Since the terminal described in this embodiment includes the device for a call described in the above embodiment, the terminal described in this embodiment will display the multimedia information while displaying the number of the calling terminal if the multimedia information is included in the calling request received by this terminal; therefore, the calling process is enabled to be individualized and interesting. Meanwhile, an effective judgment can be made on whether the call is answered by this terminal according to the content of the multimedia information. Hence, the individualized calling request leads to great improvement of practicability and interestingness of calling.

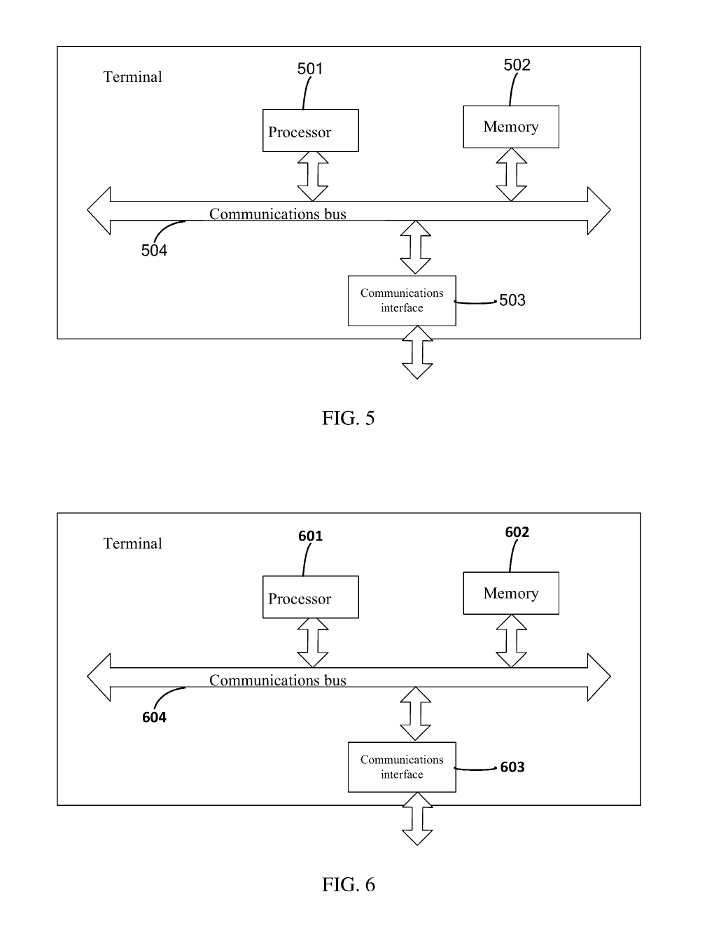

FIG. 5 shows the structural block diagram of the terminal provided by another embodiment of the present disclosure.

Referring to FIG. 5, the terminal includes:

a processor 501, a memory 502, a communications interface 503 and a bus 504, wherein

the processor 501, the memory 502 and the communications interface 503 implement communications with each other by means of the bus 504;

the communications interface 503 is used for transmitting information between the terminal and a called terminal;

the processor 501 is used for calling logical instructions in the memory 502 to execute the following method:

receiving an identifier of a called terminal and multimedia information that are input by a user; generating a calling request message according to an identifier of a calling terminal, the identifier of the called terminal and the multimedia information; sending the calling request message to the called terminal.

Referring to FIG. 1, another embodiment of the present disclosure discloses a computer program, including program codes for executing the following operations:

receiving by a calling terminal an identifier of a called terminal and multimedia information that are input by a user;

generating a calling request message according to an identifier of the calling terminal, the identifier of the called terminal and the multimedia information;

sending the calling request message to the called terminal.

Yet another embodiment of the present disclosure discloses a storage medium that is used for storing the computer program as described in the above embodiment.

FIG. 6 shows the structural block diagram of the terminal provided by another embodiment of the present disclosure.

Referring to FIG. 6, the terminal includes:

a processor 601, a memory 602, a communications interface 603 and a bus 604, wherein

the processor 601, the memory 602 and the communications interface 603 implement communications with each other by means of the bus 604;

the communications interface 603 is used for transmitting information between the terminal and a calling terminal;

the processor 601 is used for calling logical instructions in the memory 602 to execute the following method:

receiving a calling request message sent by a calling terminal, wherein the calling request message includes an identifier of the calling terminal, an identifier of a called terminal and multimedia information; displaying the identifier of the calling terminal, and simultaneously displaying the multimedia information.

Referring to FIG. 2, still another embodiment of the present disclosure discloses a computer program, including program codes for executing the following operations:

receiving by a called terminal a calling request message sent by a calling terminal, wherein the calling request message includes an identifier of the calling terminal, an identifier of the called terminal and multimedia information;

displaying by the called terminal the identifier of the calling terminal, and simultaneously displaying the multimedia information.

FIGS. 5-6 are schematic diagrams of a hardware structure of an electronic device for executing a processing method of list item operations provided by the embodiments of the disclosure. The device includes: one or more processors and a memory, with one processor as an example in FIGS. 5-6.

The device for executing a processing method of list item operations provided by the embodiments of the disclosure may also include: an input device and an output device.

As a non-volatile computer-readable storage medium, the memory is available for storing non-volatile software programs, non-volatile computer-executable programs and modules, such as program instructions/modules corresponding to the processing method of list item operations in the embodiments of the present disclosure. By running non-volatile software programs, instructions and modules stored in the memory, the processor executes various function applications and data processing of a server, i.e., achieving the processing method of list item operations in the above method embodiments.

The memory may include a program storage region and a data storage region, wherein the program storage region is available for storing an operating system, and at least one functionally required application; the data storage region is available for storing data created according to the use of a processing device of list item operations, and the like. In addition, the memory may include a high-speed random access memory, and may also include a non-volatile memory, such as at least one magnetic disk storage device, a flash memory device, or other non-volatile solid-state storage devices. In some embodiments, the memory optionally includes memories remotely set with respect to the processor; these remote memories are connectable to the processing device of list item operations by means of networks. Examples of the networks include, but are not limited to, Internet, Intranet, LAN, mobile communication networks and combinations thereof.

The input device is capable of receiving input digit or character information, and producing key signal inputs related to user settings and function control of the processing device of list item operations. The output device may include a display device such as a display screen.

The one or more modules are stored in the memory, and execute the processing method of list item operations in any above method embodiment when executed by the one or more processors.

The products described above are capable of executing the method provided by the embodiments of the present disclosure, and has corresponding function modules for executing the method and beneficial effects. Those technical details not described in detail in the present embodiment may be found in the method provided by the embodiments of the present disclosure.

The electronic device provided by this embodiment of the present disclosure may be present in a plurality of forms, including but not limited to:

(1) Mobile communication equipment: such equipment is characterized by mobile communication functions and mainly intended to provide voice and data communications. Terminals of this type include: smart phones (e.g., iPhone), multimedia mobile phones, functional mobile phones, low-end mobile phones and so on.

(2) Ultra-mobile personal computer equipment: such equipment falls into the category of personal computers, has computing and processing functions, and generally also has a mobile network access characteristic. Terminals of this type include: PDA, MID, UMPC equipment, and the like, for example iPad.

(3) Portable entertainment equipment: such equipment is able to display and play multimedia contents, and includes: audio and video players (e.g., iPod), handheld game players, electronic book readers, and smart toys and portable vehicle-mounted navigation equipment.

(4) Servers: they are equipment providing computing service. Components of a server include a processor, a hard disk, a memory, a system bus and the like. The architecture of a server is similar to that of a general-purpose computer; however, since servers are required to provide highly reliable services, requirements in such aspects as processing ability, stability, reliability, safety, extendibility and manageability are relatively high.

(5) Other electronic devices having the function of data interaction.

The embodiment of the present disclosure provides a non-volatile computer storage medium on which computer-executable instructions available for executing the processing method of list item operations in any method embodiment described above are stored, wherein the storage medium can be a magnetic disk, an optical disk, a read-only memory (ROM), a random access memory (RAM) or the like.

The device embodiments described above are merely schematic, in which units described as separate parts may be or may be not physically separated from one another, and parts displayed as units may be or may be not physical units, i.e., may be located at one place or distributed to a plurality of network units. Part or all of the modules therein may be selected according to actual requirements to achieve the objectives of the solutions in the present embodiment.

According to the above description of the embodiments, a person skilled in the art can clearly understand that various embodiments may be implemented by means of software in combination with a necessary general-purpose hardware platform, and of course, may also be implemented by means of hardware. Based on such understanding, the above technical solutions substantially or the parts making a contribution to the prior art may be embodied in the form of a software product, which can be stored in a computer-readable storage medium, such as an ROM/RAM, a magnetic disk, an optical disk or the like, and which includes a plurality of instructions for causing a computer device (which can be a personal computer, a server, a network device or the like) to execute various embodiments or the method described in some parts of the embodiments.

Finally, it should be noted that the above embodiments are merely intended to illustrate, rather than limit, the technical solutions of the embodiments of the present disclosure. Although the embodiments of the present disclosure are illustrated in detail with reference to the aforementioned embodiments, a person of ordinary skill in the art should understand that modifications may still be made to the technical solutions recorded in the aforementioned embodiments or equivalent substitutions may be made to part or all of technical features therein; these modifications and substitutions do not cause the nature of the corresponding technical solutions to depart from the scope of the technical solutions in the embodiments of the present disclosure.

What is claimed is:

1. A method for a call, comprising:
receiving by a calling terminal an identifier of a called terminal and multimedia information that are input by a user;
generating a calling request message according to an identifier of the calling terminal, the identifier of the called terminal and the multimedia information;
sending the calling request message to the called terminal.

2. The method according to claim 1, wherein the identifier of the called terminal comprises: identity (ID) information of the called terminal, Internet protocol (IP) information of the called terminal or Media Access Control (MAC) address information of the called terminal;
the identifier of the calling terminal comprises: identity (ID) information of the calling terminal, Internet protocol (IP) information of the calling terminal or Media Access Control (MAC) address information of the calling terminal.

3. The method according to claim 1, wherein the step of receiving by the calling terminal the identifier of the called terminal and the multimedia information that are input by the user comprises:
sending by the calling terminal a prompt message for prompting the user whether to add the multimedia information upon receiving the identifier of the called terminal input by the user;
acquiring the multimedia information input by the user and having capacity smaller than a preset threshold if the user determines to add the multimedia information.

4. The method according to claim 1, wherein the multimedia information comprises:
audio information, video information or image information stored at a preset address; and/or
audio information, video information or image information input by means of a microphone or a camera; and/or
text information input by means of a keyboard.

5. An electronic device, comprising:
at least one processor; and
a memory communicably connected with the at least one processor for storing instructions executable by the at least one processor, wherein execution of the instructions by the at least one processor causes the at least one processor to:
receive an identifier of a called terminal and multimedia information that are input by a user;
generate a calling request message according to an identifier of a calling terminal, the identifier of the called terminal and the multimedia information;
send the calling request message to the called terminal.

6. The device according to claim 5, wherein the identifier of the called terminal comprises: identity (ID) information of the called terminal, Internet protocol (IP) information of the called terminal or Media Access Control (MAC) address information of the called terminal;
the identifier of the calling terminal comprises: identity (ID) information of the calling terminal, Internet protocol (IP) information of the calling terminal or Media Access Control (MAC) address information of the calling terminal.

7. The device according to claim 6, wherein the processor is further configured to perform the following steps:
sending a prompt message for prompting the user whether to the add multimedia information upon receiving the identifier of the called terminal input by the user;
acquiring the multimedia information input by the user and having capacity smaller than a preset threshold if the user determines to add the multimedia information.

8. The device according to claim 7, wherein the multimedia information comprises:
audio information, video information or image information stored at a preset address; and/or
audio information, video information or image information input by means of a microphone or a camera; and/or
text information input by means of a keyboard.

9. A non-transitory computer-readable storage medium storing executable instructions that, when executed by an electronic device with a touch-sensitive display, cause the electronic device to:
receive by a calling terminal an identifier of a called terminal and multimedia information that are input by a user;
generate a calling request message according to an identifier of the calling terminal, the identifier of the called terminal and the multimedia information;
send the calling request message to the called terminal.

10. The non-transitory computer-readable storage medium according to claim 9, wherein the identifier of the called terminal comprises: identity (ID) information of the called terminal, Internet protocol (IP) information of the called terminal or Media Access Control (MAC) address information of the called terminal;
the identifier of the calling terminal comprises: identity (ID) information of the calling terminal, Internet protocol (IP) information of the calling terminal or Media Access Control (MAC) address information of the calling terminal.

11. The non-transitory computer-readable storage medium according to claim 10, wherein the electronic device is further configured to perform the following steps:
sending a prompt message for prompting the user whether to the add multimedia information upon receiving the identifier of the called terminal input by the user;
acquiring the multimedia information input by the user and having capacity smaller than a preset threshold if the user determines to add the multimedia information.

12. The non-transitory computer-readable storage medium according to claim 11, wherein the multimedia information comprises:
audio information, video information or image information stored at a preset address; and/or
audio information, video information or image information input by means of a microphone or a camera; and/or
text information input by means of a keyboard.
